(19) United States
(12) Patent Application Publication
(10) Pub. No.: US 2010/0150816 A1
(43) Pub. Date: Jun. 17, 2010

(54) Methods for Purifying an Aqueous Hydrochloric Acid Solution

(75) Inventors: Stephen W. Oldiges, Hockessin, DE (US); Mark Andrew Harmer, Landenberg, PA (US); Jesse S. Jones, Woodstown, NJ (US); David C. Confer, Knoxville, TN (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I.DuPont De Nemours and Company, Wilmington (DE)

(21) Appl. No.: 12/516,680

(22) PCT Filed: Nov. 28, 2007
(86) PCT No.: PCT/US07/24515

§ 371 Date: Feb. 2, 2010

Related U.S. Application Data
(60) Provisional application No. 60/861,379, filed on Nov. 28, 2006.

(51) Int. Cl. C01B 7/07

(52) U.S. Cl. 423/488

(57) ABSTRACT

Methods for purifying an aqueous hydrochloric acid solution waste stream having an impurity fraction comprising an initial Ti fraction, an initial S fraction and an initial Si fraction; that provide purified aqueous hydrochloric acid solutions having a final Ti fraction of less than 250 ppm, a final S fraction of less than 200 ppm, and a final Si fraction of less than 10 ppm, which may be determined with inductively coupled plasma spectroscopy. Process steps in various embodiments include sparging with an gas; mixing the sparged solution with a precipitation agent comprising a sufficient amount of an alkali earth metal salt and, optionally, a phosphoric acid source, to provide a metal salt precipitate; and mixing the initial aqueous acid solution or, optionally, the sparged aqueous acid solution, with a flocculating polymer. A preferred alkali earth metal salt is barium chloride and preferred flocculating polymers are poly(diallyldialkylammonium chloride) homopolymers and copolymers.

This application claims the benefit of U.S. Provisional Application No. 60/861,379, filed Nov. 28, 2006, which is incorporated in its entirety as a part hereof for all purposes.

### TECHNICAL FIELD

This invention is related to the chemical treatment of an aqueous hydrochloric acid stream.

### BACKGROUND

Many industrial processes produce waste streams of hydrochloric acid that, typically, are neutralized with base and disposed of to a river, preferably a coastal estuary. This is an expensive process and adds significantly to the cost of manufacture. Recycling the acid stream would be desirable, but in many cases the hydrochloric acid is contaminated with unacceptable levels of metal ions.

Various types of wastewater processes are known. U.S. Pat. No. 5,219,542, for example, discloses a process for removing sulfur compounds from a fluid stream; and U.S. Pat. No. 5,965,027 discloses a process for removing silica from wastewater. A need nevertheless remains for an inexpensive and reliable method for purifying aqueous hydrochloric acid solutions such that the solutions can be recycled into commercial manufacturing processes. Of particular need is a method for removing Ti, S and Si from aqueous hydrochloric acid solutions.

### SUMMARY

In one embodiment, this invention provides a method for purifying an aqueous hydrochloric acid solution by (a) providing an initial aqueous acid solution having an impurity fraction comprising an initial S fraction and an initial Ti fraction; (b) sparging the initial aqueous acid solution with a sparge gas to provide a sparged acid solution having, as sparged, an S fraction of less than 2000 ppm; (c) mixing the sparged acid solution with a precipitation agent comprising an alkali earth metal salt to provide a metal salt precipitate and a supernatant; and (d) recovering the supernatant from the metal salt precipitate to provide a purified aqueous acid solution having a final S fraction of less than 200 ppm.

In another embodiment, this invention provides a method for purifying an aqueous hydrochloric acid solution by (a) providing an initial aqueous acid solution having an impurity fraction comprising an initial Ti fraction, an initial S fraction and an initial Si fraction; (b) mixing the initial aqueous acid solution with a flocculating polymer to provide a polymer flocculation and a supernatant; (c) separating the polymer flocculation from the supernatant to provide a purified supernatant; (d) sparging the purified supernatant with a sparge gas to provide a sparged supernatant having, as sparged, an S fraction less than 2000 ppm, and an Si fraction of less than 10 ppm; (e) mixing the sparged supernatant with a precipitation agent comprising an alkali earth metal salt and, optionally, a phosphoric acid source to provide a metal salt precipitate; and (f) separating the metal salt precipitate to provide a purified aqueous hydrochloric acid solution having a final S fraction of less than 200 ppm, and a final Si fraction of less than 10 ppm.

In a further embodiment, this invention provides a method for purifying an aqueous hydrochloric acid solution comprising (a) providing an initial aqueous acid solution having an impurity fraction comprising an initial Ti fraction and an initial S fraction; (b) sparging the initial aqueous acid solution with a sparge gas to provide a sparged acid solution having, as sparged, an S fraction less than 2000 ppm; (c) mixing the sparged acid solution with a flocculating polymer to provide a polymer flocculation and a supernatant; (d) separating the polymer flocculation from the supernatant to provide a sparged flocculation supernatant; (e) mixing the sparged flocculation supernatant with a precipitation agent comprising an alkali earth metal salt and, optionally, a phosphoric acid source to provide a metal salt precipitate; and (f) separating the metal salt precipitate to provide a purified aqueous acid solution having a final S fraction of less than 200 ppm.

### DETAILED DESCRIPTION

An aqueous solution of hydrochloric acid as treated by the methods hereof (an “initial aqueous acid solution”) may contain, for example, about 8 wt % to about 25 wt % hydrochloric acid, or alternatively about 18 wt % to about 22 wt % hydrochloric acid. Contained within the initial aqueous hydrochloric acid solution are impurities, such as Ti, S and Si, that need to be removed, or reduced in content, to provide a purified aqueous acid solution. These impurities may include, for example, an initial Ti fraction in amount greater than 500 ppm; an initial S fraction in an amount greater than 2000 ppm; and/or an initial Si fraction in an amount greater than 100 ppm.

Sparging, as a step of treatment to be performed on the initial aqueous acid solution, may be accomplished by passing a sparge gas through the aqueous acid solution such as by spraying through a perforated pipe located within the solution. This may be done at a rate of about 80 to about 2000 liters per hour (L/h), and preferably about 500 to 1200 L/h. Sparging is preferably accomplished at about 20 to about 40° C. The sparge gas can be any convenient gas, but is preferably selected from the group consisting of: air, nitrogen and oxygen. Air is a preferred gas. A sparge volume in an amount of about 50 to 2000 times the total volume of the initial aqueous acid solution is generally suitable. Although the invention is not limited to any particular theory of operation, sparging is generally believed to affect a reduction in the overall S content of the aqueous solution of acid by removing volatile sulfur impurities. When air or oxygen is used as the sparge gas, certain sulfur impurities may in addition undergo oxidation to higher oxidation states including sulfate, creating species that can then be removed with the precipitation agent. Treating an initial aqueous acid solution with a sparge gas may provide an aqueous acid solution having, as sparged, an S fraction of less than 2000 ppm.

In one embodiment, a precipitation agent as used herein to treat an aqueous solution of hydrochloric acid includes an alkali earth metal salt that will, through contact with impurities in the initial aqueous acid solution, provide a metal salt precipitate. Alkali earth metal salts useful as a precipitation agent include those selected from the group consisting of: magnesium nitrate, magnesium bromide, magnesium chloride, magnesium iodide, magnesium acetate, magnesium carbonate, magnesium oxalate, calcium nitrate, calcium chloride, calcium bromide, calcium iodide, calcium carbonate, calcium acetate, calcium oxalate, strontium nitrate, strontium bromide, strontium chloride, strontium iodide, strontium acetate, strontium carbonate, strontium oxalate, barium nitrate, barium bromide, barium chloride, barium iodide, barium acetate, barium carbonate, and barium oxalate. Preferred are the alkali earth metal halide salts of chloride and bromide. Barium chloride is especially preferred, and can be used in the form of the anhydrous salt or the hydrated or partially hydrated form. Preferably the precipitation agent comprises an aqueous solution of barium chloride. A solution such as about 20 wt % barium chloride in water is generally suitable. An alkali earth metal salt, such as barium chloride, may be used in an amount of about 0.8 to 1.2 equivalents, or about 0.9 to 1.1 equivalents, of the alkali earth metal salt per equivalent of S in the aqueous acid solution as sparged.

In an alternative embodiment, the precipitation agent can, optionally, further include a phosphoric acid source that will, through contact with impurities in the initial aqueous acid solution, provide a metal salt precipitate. The phosphoric acid source can be any phosphoric acid derivative that, upon dissolution in hydrochloric acid, provides a source of phosphoric acid. Phosphoric acid sources include phosphoric acid, phosphorous pentoxide, polyphosphoric acid, alkali metal hydrogen phosphates such as sodium monohydrogen phosphates and sodium dihydrogen phosphates, and the like. Preferred phosphoric acid sources are polyphosphoric acid and phosphorous pentoxide. A phosphoric acid source may be used in an amount of about 0.8 to about 1.2 equivalents of phosphoric acid source per equivalent of Ti in the initial aqueous acid solution. Use of a precipitation agent may provide a purified aqueous acid solution having a final S fraction of less than 200 ppm, a final Si fraction of less than 50 ppm, and/or a final Ti fraction of less than 250 ppm.

Mixing the sparged acid solution with the precipitation agent can be done at any desired temperature, but lower temperatures are generally better for inducing precipitation of larger particle size. A preferred temperature range is about 30 to about 40° C., but lower or higher temperatures can be used. Mixing the sparged acid solution with the precipitation agent can be done either by adding the precipitation agent to the acid solution, or by adding the acid solution to the precipitation agent. Preferably, the sparged acid solution is added to the precipitation agent with stirring.

In one embodiment, mixing of the sparged acid solution with the precipitation agent may be performed by (i) adding and mixing a first portion of the sparged acid solution into the precipitation agent over a first time period; and (ii) adding and mixing one or more additional portion(s) of the sparged acid solution into the precipitation agent over one or more additional time period(s) to provide the metal salt precipitate. The first portion of the sparged acid solution may be about 10% to about 60%, and preferably about 20% to about 55%, of the total process volume; and the one or more additional portion(s) may be the remainder of the total process volume, or halves or thirds thereof. The first time period may be about 0.2 to about 24 hours, and preferably about 0.5 to about 2 hours. The one or more additional time period(s) may be about 0.1 to about 72 hours, and preferably 0.5 to about 72 hours. In a further embodiment, the first portion of the sparged acid solution is added within about 20% of the first time period, and stirring is continued throughout the first time period. Although the invention is not limited to any particular theory of operation, mixing in sequential steps (as described above) is generally believed to affect a more efficient metal salt precipitation by allowing favorable conditions for formation of precipitate particles.

Separating the metal salt precipitate can be performed by any method commonly used for removing metal salt precipitates such as: allowing the metal salt precipitate to settle and decanting the resulting supernatant, which forms a separate layer in the production vessel over the other components; filtering the metal salt precipitate; or centrifugation of the metal salt precipitate. A preferred method involves allowing the metal salt precipitate to settle and decanting the resulting supernatant. The supernatant subsequently can be filtered, to further improve the purity of the acid solution, if so desired. Another useful method involves filtering the metal salt precipitate. Preferred filter media for this step include about 0.2 to about 1.0 micron, and preferably about 0.2 to about 0.45 micron, polypropylene, polyvinylidene fluoride (PVDF) or polytetrafluoroethylene (PTFE) filters. Specific filters useful herein for such purpose include FP VERICEL™ PVDF filters, GHP ACRODISC® filters, and SUPOR® hydrophilic polyethersulfone membranes, all available from Pall Corp., East Hills, N.Y. 11548.

In another embodiment, the methods hereof may be performed by mixing the initial aqueous acid solution with a flocculating polymer to provide a polymer flocculation and a supernatant. The polymer flocculation may then be separated from the supernatant to provide a purified supernatant, and the purified supernatant may then be sparged with a sparge gas, in the same manner as described above, to provide a sparged supernatant. In a preferred embodiment, separation is effected by allowing the polymer flocculation to settle, and the supernatant is then decanted from the flocculation by, for example, pumping off the supernatant layer. After sparging, the sparged supernatant may then be admixed with a precipitation agent, such as an alkali earth metal salt and/or a phosphoric acid source, in the same manner as described above, to provide a metal salt precipitate. If desired, the supernatant may be filtered before proceeding with the addition of the precipitating agent. Separating the metal salt precipitate from the supernatant provides a purified supernatant.

In yet another embodiment, the steps described above may be transposed, and the initial aqueous acid solution may be sparged with a sparge gas, in the same manner as described above, to provide a sparged acid solution. The sparged acid solution may then be admixed with a flocculating polymer to provide a polymer flocculation and a supernatant. The polymer flocculation may then be separated from the supernatant to provide a purified supernatant. In a preferred embodiment, separation is effected by allowing the polymer flocculation to settle, and the supernatant is then decanted from the flocculation by, for example, pumping off the supernatant layer. After separation, the purified supernatant may then be admixed with a precipitation agent, such as an alkali earth metal salt and/or a phosphoric acid source, in the same manner as described above, to provide a metal salt precipitate. If desired, the supernatant may be filtered before proceeding with the addition of the precipitating agent. Separating the metal salt precipitate from the supernatant provides a purified supernatant.

A flocculating polymer may be used for the purposes described above in an amount of about 0.001 to about 0.1 wt % based on the weight of the initial aqueous acid solution and based on the dry weight of the flocculating polymer. Flocculating polymers suitable for use herein include the general class of cationic polyelectroytes as disclosed by Thomson in the chapter entitled “Preparation of Ionic Polymers” in Developments in Ionic Polymers 2, Wilson and Prosser, Eds., Elsevier Applied Science Pub., New York, 1986, pp. 36-60. Preferred flocculating polymers include poly(diallyldialkylammonium chloride) homopolymers and copolymers with acrylamide, and epichlorohydrin/dimethylamine polymer, and other water soluble monomers. Specific poly(diallyldialkylammonium chloride) homopolymers and copolymers useful as flocculating polymers are poly(diallyldimethylammonium chloride) (pDADMAC) homopolymer and copolymers comprising greater than 30 mol %, and preferably greater than 50 mol %, diallyldimethylammonium chloride. Other preferred polymers are an epichlorohydrin/dimethylamine polymer having an average molecular weight of about 250,000 to about 500,000.

Use of a flocculating polymer together with sparging and precipitation, as described above, may provide a purified aqueous acid solution having a final S fraction of less than about 200 ppm, a final Ti fraction of less than 250 ppm, and/or a final Si fraction of less than about 10 ppm.

Analysis of the various initial and purified aqueous acid solutions to determine the content of impurities therein, such as the Ti, Si and S fractions, may be performed, for example, by inductively coupled plasma (ICP) spectroscopy with a Perkin-Elmer 5300 ICP using U.S. Environmental Protection Agency Method 6010.

The following examples are illustrative only, and are not to be read as limiting the scope of the invention as it is defined by the appended claims.

### Materials and Methods

The aqueous hydrochloric acid solution used in various examples was an acid waste stream from a scrubber communicating with effluent gases of a commercial titanium dioxide manufacturing plant. Barium chloride, phosphoric acid, phosphorous pentoxide and other chemical reagents were available from Aldrich Chemical Co., Milwaukee, Wis.

Inductively coupled plasma (ICP) spectroscopy to determine the Ti, Si and S fraction of the initial aqueous acid and purified acid solutions was performed with a Perkin-Elmer 5300 ICP using U.S. Environmental Protection Agency Method 6010.

### Example 1

### Sparging with a Gas to Reduce the Sulfur Fraction of an Aqueous Hydrochloric Acid Solution

Approximately 1 L of aqueous hydrochloric acid (23.0 wt % HCl) from a commercial waste stream was placed in an open plastic bottle and sparged with nitrogen gas at a flow rate of approximately 840 L/h. This was accomplished by submerging one end of a 2 mm ID glass sparge tube in the aqueous hydrochloric acid, the other end of which was attached by latex tubing to a pressurized nitrogen manifold. The duration of sparging was one hour. The sparged acid solution, analyzed by ICP spectroscopy, was found to have a sulfur content of 901 ppm versus a sulfur content of 7901 ppm in the untreated acid solution.

A second run, using air rather than nitrogen, gave a sparged acid solution having a sulfur content of 973 ppm versus 7901 ppm in the untreated acid solution.

### Example 2

### Sparging with a Gas Followed by Treatment with Barium Chloride to Reduces the Sulfur Fraction

The initial hydrochloric acid solution (23.0 wt %) was sparged with nitrogen as described in Example 1. The sparged acid solution (20 mL) was added dropwise over a period of 30 min to a stirred solution of barium chloride (0.20 g) in de-ionized water (0.8 mL). The mixture was stirred for an additional 1.5 h and filtered immediately using a syringe filter having a polypropylene membrane (0.45 micron, GHP ACRODISC®, Pall Corp). ICP analysis showed a sulfur fraction of 27 ppm versus 5577 ppm in the initial solution.

### Example 3 (Comparative)

### Treatment with Barium Chloride without Sparging the Acid Solution

The initial hydrochloric acid solution (23.0 wt %) was added dropwise over a period of 30 min to a stirred solution of barium chloride (0.20 g) in de-ionized water (0.8 mL). The mixture was stirred for 1.5 h and filtered as described in Example 2. ICP analysis showed a sulfur fraction of 1459 ppm versus 5577 ppm in the initial solution.

### Example 4

### Treatment with Phosphoric Acid to Reduces the Titanium Fraction

The initial hydrochloric acid solution (23.0 wt %) was sparged with nitrogen as described in Example 1. A portion of the sparged acid solution (12.5 mL) was added to phosphoric acid (0.277 g) with stirring, and the stirring continued for 1 h. A further portion of the sparged acid solution (37.5 mL) was added and the stirring continued for 5 h, followed by filtration as described in Example 2. The filtered solution, analyzed by ICP, showed a titanium fraction of 144 ppm versus a fraction of 1072 ppm in the initial acid solution.

A similar run, wherein the entire sparged acid solution (50 mL) was added over a period of 1 hour, produced a filtered solution with a titanium fraction of 167 ppm.

A similar run, wherein the entire sparged acid solution (50 mL) was added all at once, produced a flocculation that plugged the filter after passage of about 2% of the solution. The filtered solution showed a titanium fraction of 153 ppm.

### Example 5

A hydrochloric acid solution (2 L aqueous solution, 23 wt %), obtained from industrial waste stream, was sparged with air as described in Example 1. To a 1 gallon carboy fitted with a mechanical stirrer and bottom drain port, was added phosphoric acid (10 g, 86 wt %) followed by barium chloride (16 g) dissolved in de-ionized water (38 ml). A portion of the sparged acid solution (500 mL) was added to the carboy and stirred at 100 rpm. The mixture was allowed to stir for 1 h before adding the remaining 1.5 L of acid solution. Stirring was stopped after 3 h, and within 45 min a precipitate settled to the bottom 1″ of the tank. A portion of the clear supernatant was decanted from the precipitate and filtered on a PVDF membrane (0.45 pore size, 47 mm, FP VERICEL™ PVDF membrane, Pall Corp) to provide a Part A final purified acid solution. The remaining supernatant and precipitate where stirred for an additional 15 hours, followed by settling for 2.5 hours to provide a clear supernatant. The supernatant was decanted and filtered as described above to provide a Part B final purified acid solution. The filtered acid solutions, analyzed by ICP spectroscopy, showed Ti, S and Si levels listed in the following table.

| | Ti fraction | S fraction | Si fraction |
|---|---|---|---|
| Sample | (ppm) | (ppm) | (ppm) |
| Initial acid | 2045 | 7658 | 93 |
| solution | | | |
| Part A final | 240 | 95 | 8 |
| acid | | | |
| Part B final | 190 | 80 | 3 |
| acid | | | |

### Example 6

### Treatment with (pDADMAC) to Reduce the Si Fraction

In a series of 12 runs, initial hydrochloric acid solutions (17.6 wt %) obtained from industrial waste stream were added to containers equipped with a mechanical stirrer set to run at 87 rpm. Poly (diallyldimethylammonium chloride) (“pDADMAC”) polymers were diluted to 1 or 10 vol % by addition of 99 parts or 9 parts de-ionized water to the commercial material with stirring for 0.5 hour to provide diluted flocculating polymer solutions. The acid solution was treated with the diluted flocculating polymer solutions at four different dosage levels: 100, 200, 400 and 800 ppm, on a volume basis of the commercial material. The diluted flocculating polymer solutions were added to the aqueous acid solution while mixing. After stirring for 3 min, the stirrer was stopped and the mixtures allowed to stand for 20 min to provide clear supernatants. Samples of the supernatants were withdrawn and analyzed by ICP spectroscopy. All samples showed a Si fraction of less than 1 ppm versus 166 ppm for the initial acid solution.

### Example 7

### Sparging, Flocculation Polymer (at Two Dosage Levels) and Precipitation Agent

Initial hydrochloric acid solutions (23.0 wt %) are sparged with nitrogen as described in Example 1. pDADMAC polymer is diluted to 1 or 10 vol % by addition of 99 parts or 9 parts de-ionized water to the commercial material with stirring for 0.5 hour to provide diluted flocculating polymer solutions. The sparged acid solutions are treated with the diluted flocculating polymer solutions at a dosage of 50 or 500 ppm on a volume basis of the commercial flocculating polymer. The diluted flocculating polymer solutions are added to the aqueous acid solutions while mixing at a moderate rate of about 100 to 300 rpm. Mixing is continued for three minutes after the diluted flocculating polymer solution is added, and the solutions are permitted to stand for 20 min. Hazy flocculations in the bottom of the treatment vessels form. The flocculations are separated from the supernatant via decanting, or the flocculations are drained from the bottom of treatment vessels.

Stoichiometric quantities of H₃PO₄ (based on a 1:1 stoichiometric ratio of phosphorous to titanium in the initial acid solution) are added to the vessels. Stoichiometric quantities of BaCl₂, based on a 1:1 stoichiometric ratio of barium to sulfur in the sparged aqueous acid solution, are added to the same vessels. A portion of the above supernatants representing about 25% of the total are then added to the same vessels while stirring at 500 rpm. The remainders of the supernatants are added to the vessels one hour later. Stirring is maintained for an additional 5 hours. The resulting flocculations are filtered using a polypropylene filtration membrane (0.45 micron) to provide purified aqueous hydrochloric acid solutions.

### Example 8

Example 7 is repeated, but the initial hydrochloric acid solution is treated with pre-diluted pDADMAC polymers at the two dosage levels (50 and 500 ppm); and the resulting supernatants are sparged with nitrogen as in Example 1, followed by treatment with H₃PO₄ and BaCl₂ to provide purified aqueous hydrochloric acid solutions.

What is claimed is:

1. A method for purifying an aqueous hydrochloric acid solution comprising:
(a) providing an initial aqueous acid solution having an impurity fraction comprising an initial S fraction and an initial Ti fraction;
(b) sparging the initial aqueous acid solution with a sparge gas to provide a sparged acid solution having, as sparged, an S fraction of less than 2000 ppm;
(c) mixing the sparged acid solution with a precipitation agent comprising an alkali earth metal salt to provide a metal salt precipitate and a supernatant; and
(d) recovering the supernatant from the metal salt precipitate to provide a purified aqueous acid solution having a final S fraction of less than 200 ppm.

2. The method of claim 1 wherein the alkali earth metal salt comprises barium chloride.

3. The method of claim 1 wherein the precipitation agent further comprises a phosphoric acid source.

4. The method of claim 1 wherein the alkali earth metal salt is provided in an amount of about 0.8 to 1.2 equivalents per equivalent of S in the sparged acid solution.

5. The method of claim 3 wherein the phosphoric acid source is provided in an amount of about 0.8 to about 1.2 equivalents per equivalent of Ti in the initial aqueous acid solution.

6. The method of claim 1 wherein step (c) comprises the steps of
(i) adding a first portion of the sparged acid solution to the precipitation agent over a first time period;
(ii) adding one or more additional portion(s) of the sparged acid solution to the precipitation agent over one or more additional time period(s);
wherein the first portion comprises about 10% to about 60% of the total process volume, and the one or more additional portion(s) comprise a remainder percent of the total process volume; and
wherein the first time period is from about 0.2 to about 24 hours, and the one or more additional time period(s) are from about 0.1 to about 72 hours.

7. The method of claim 1 wherein step (d) comprises a step of filtering off the metal salt precipitate, or a step of settling the metal salt precipitate and decanting the supernatant.

8. A method for purifying an aqueous hydrochloric acid solution comprising:
(a) providing an initial aqueous acid solution having an impurity fraction comprising an initial Ti fraction, an initial S fraction and an initial Si fraction;
(b) mixing the initial aqueous acid solution with a flocculating polymer to provide a polymer flocculation and a supernatant;
(c) separating the polymer flocculation from the supernatant to provide a purified supernatant;
(d) sparging the purified supernatant with a sparge gas to provide a sparged supernatant having, as sparged, an S fraction less than 2000 ppm, and an Si fraction of less than 10 ppm;
(e) mixing the sparged supernatant with a precipitation agent comprising an alkali earth metal salt and, optionally, a phosphoric acid source to provide a metal salt precipitate; and
(f) separating the metal salt precipitate to provide a purified aqueous hydrochloric acid solution having a final S fraction of less than 200 ppm, and a final Si fraction of less than 10 ppm.

9. The method of claim 8 wherein the alkali earth metal salt comprises barium chloride.

10. The method of claim 8 wherein the flocculating polymer is provided in an amount of about 0.001 to about 0.1 wt % based on the weight of the initial aqueous acid solution and based on the dry weight of the flocculating polymer.

11. The method of claim 8 wherein the flocculating polymer is selected from the group consisting of poly(diallyldialkylammonium chloride) homopolymer, and copolymers thereof with acrylamide, and epichlorohydrin/dimethylamine polymer.

12. The method of claim 8 wherein the alkali earth metal salt is provided in an amount of about 0.8 to 1.2 equivalents per equivalent of S in the sparged acid solution.

13. The method of claim 8 wherein a phosphoric acid source is provided in an amount of about 0.8 to about 1.2 equivalents per equivalent of Ti in the initial aqueous acid solution.

14. A method for purifying an aqueous hydrochloric acid solution comprising:
(a) providing an initial aqueous acid solution having an impurity fraction comprising an initial Ti fraction and an initial S fraction;
(b) sparging the initial aqueous acid solution with a sparge gas to provide a sparged acid solution having, as sparged, an S fraction less than 2000 ppm;
(c) mixing the sparged acid solution with a flocculating polymer to provide a polymer flocculation and a supernatant;
(d) separating the polymer flocculation from the supernatant to provide a sparged flocculation supernatant;
(e) mixing the sparged flocculation supernatant with a precipitation agent comprising an alkali earth metal salt and, optionally, a phosphoric acid source to provide a metal salt precipitate; and
(f) separating the metal salt precipitate to provide a purified aqueous acid solution having a final S fraction of less than 200 ppm.

15. The method of claim 14 wherein the alkali earth metal salt comprises barium chloride.

16. The method of claim 14 wherein the flocculating polymer is provided in an amount of about 0.001 to about 0.1 wt % based on the weight of the initial aqueous acid solution and based on the dry weight of the flocculating polymer.

17. The method of claim 14 wherein the flocculating polymer is selected from the group consisting of poly(diallyldialkylammonium chloride) homopolymer, and copolymers thereof with acrylamide, and epichlorohydrin/dimethylamine polymer.

18. The method of claim 14 wherein the alkali earth metal salt is provided in an amount of about 0.8 to 1.2 equivalents per equivalent of S in the sparged acid solution.

19. The method of claim 14 wherein a phosphoric acid source is provided in an amount of about 0.8 to about 1.2 equivalents per equivalent of Ti in the initial aqueous acid solution.

20. The method of claim 1, 8 or 14 wherein the purified aqueous acid solution has a final Ti fraction of less than 250 ppm and/or a final Si fraction of less than 10 ppm.
